(19) United States
(12) Patent Application Publication
(10) Pub. No.: US 2021/0376902 A1
(43) Pub. Date: Dec. 2, 2021

(54) A NETWORK NODE AND METHOD IN A WIRELESS COMMUNICATIONS NETWORK

(71) Applicant: Telefonaktiebolaget LM Ericsson (publ), Stockholm (SE)

(72) Inventors: Per BURSTRÖM, LULEÅ (SE); Arne SIMONSSON, GAMMELSTAD (SE); Magnus THURFJELL, LULEÅ (SE); Kjell LARSSON, LULEÅ (SE); Sven-Olof JONSSON, HORTLAX (SE); Svante BERGMAN, HÄGERSTEN (SE); Bo GÖRANSSON, SOLLENTUNA (SE)

(73) Assignee: Telefonaktiebolaget LM Ericsson (publ), Stockholm (SE)

(21) Appl. No.: 17/257,416

(22) PCT Filed: Jul. 3, 2018
(86) PCT No.: PCT/SE2018/050728

§ 371 Date: Dec. 31, 2020

(51) Int. Cl. H04B 7/06; H04B 17/345; H04W 24/08

(52) U.S. Cl. CPC H04B 7/0695; H04W 24/08; H04B 17/345

(57) ABSTRACT

A method performed by a network node for reducing Inter-Symbol Interference, ISI, in a wireless communications network. The network node provides a number of beams for transmissions between the network node and respective one or more first User Equipments, UEs, and a second UE. During a time period, network node obtains (301) measures of ISI per beam out of the number of beams related to transmissions between the network node and the one or more first UEs. The network node then reduces (302) the ISI in the wireless communications network 100 by obtaining a beam for transmission between the network node and the second UE. The beam is selected out of the number of beams by taking the obtained measures of ISI per beam into account.

### TECHNICAL FIELD

Embodiments herein relate to a network node in a wireless communications network, and a method therein. In particular, they relate to reducing Inter-Symbol Interference (ISI) in a wireless communications network.

### BACKGROUND

In a typical wireless communication network, wireless devices, also known as wireless communication devices, mobile stations, stations (STA) and/or User Equipments (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

A common technique for beamforming in a wireless communication systems is to collect received power measurements on a set of candidate pilot beams, e.g. Reference Signal Received Power (RSRP) measurements per beam, and then signal these measurements or an indication of the strongest beam/s to the node transmitting the candidate pilot beams. The transmitting node may then use the strongest beam for downlink transmissions. In NR this process of identifying the strongest beam is referred to as beam management.

A propagation channel typically includes multiple propagation paths that linearly combine at the receiver with different power profiles, propagation delays and phases. Propagation delay, also referred to as the path delay, is the delay of the signal based on the distance it has traversed compared to a line-of-sight (LOS) signal. In some cases there is a strong LOS component which is accompanied by a number of multipath signals, i.e. signals that are reflected or diffracted on different objects. In other cases, the receiving node is not in LOS and only the multipath components exist in the channel.

As multipath components have different propagation paths they also have different propagation delay, i.e. the delay in time of the signal compared to the LOS signal. Typically, large propagation delays result in a large pathloss as signals are weakened with distance. Pathloss is the reduction of power of the signal as it travels through space along the path. By design, the delay spread is often confined within the limits of cyclic prefix. The cyclic prefix may also be referred to as a guard period, guard interval or cyclic prefix window and with the term is herein meant the prefixing of a symbol, with a repetition of the end of the symbol. The cyclic prefix is discarded by the receiver. The cyclic prefix provides a guard towards delay spread in the channel and by this minimize the leakage of one symbol into the next. In some cases however, especially if a reflective surface has an unfortunate placement, the propagation delay may be long and yet sufficiently strong to result in significant multipath signals breaching the cyclic prefix. Such multipath components result in so called Inter-Symbol Interference (ISI). Since such long-range reflections would originate from specific reflective objects, the strength of the reflection would depend on the beamforming applied at the transmitter node side. Some beamforming directions can therefore result in more ISI compared to other beamforming directions.

FIG. 1 shows an example diagram of measured delay spread for different beam directions. The X axis represents Horizontal beam directions in degrees. The Y axis represents Root Mean Square (RMS) of the delay spread in ns. The 95% confidence interval (CI) is also provided for each data point. The RMS is the square root of the mean arithmetic mean of the squares of the data points. The 95% CI represent the the level of confidence that the parameter lies in the interval. The example is from a driver route with a NR test-bed using a fixed Grid-of-Beam (GoB) solution. A driver route when used herein is a description where the measurements have been taken. A fixed GoB when used herein is a fixed set of beams with different directions. As can be seen from the figure, some beam directions have a significantly larger delay spread than others, such as at 2 degrees and 14 degrees.

In many cases it is sufficient to select a transmission beam based on received power measurements, as the interference as seen from the UE side is invariant with respect to the transmission beam used. The Signal to Interference plus Noise Ratio (SINR) will be approximately proportional to the RSRP measurement. However, as explained above, there are some effects that will result in a beam dependent interference level.

E.g. assume that the UE is placed in an environment where there is a reflective surface further down the line of the propagation path, i.e. beyond the UE, and that this reflective surface result in long way reflections of the signal, thus creating ISI. The UE will then experience higher interference level for the beam or beams that hits the reflective surface compared to other directions.

### SUMMARY

As beam selection by RSRP, also referred to as beam reference signals, or Channel State Information Reference Signal (CSI-RS) for beam management, does not capture the ISI-induced quality degradation, the network may experience suboptimal performance due to the use of these beams with high ISI.

Reflective surfaces and objects are typically part of the propagation environment and may often be stationary over time. It is therefore likely that a beam that resulted in high ISI in previous transmissions will statistically do so also in future transmissions.

An object of embodiments herein is to improve the transmission quality in a wireless communications network using multiple beams.

According to a first aspect of embodiments herein, the object is achieved by a method performed by a network node for reducing Inter-Symbol Interference, ISI, in a wireless communications network. The network node provides a number of beams for transmissions between the network node and respective one or more first User Equipments, UEs, and a second UE.

During a time period, the network node obtains measures of ISI per beam out of the number of beams related to transmissions between the network node and the one or more first UEs. The network node then reduces the ISI in the wireless communications network by obtaining a beam for transmission between the network node and the second UE. The beam is selected out of the number of beams by taking the obtained measures of ISI per beam into account.

According to a second aspect of embodiments herein, the object is achieved by a network node for reducing Inter-Symbol Interference, ISI, in a wireless communications network. The network node is adapted to provide a number of beams for transmissions between the network node and respective one or more first User Equipments, UEs and a second UE. The network node is configured to:

During a time period, obtain measures of ISI per beam out of the number of beams related to transmissions between the network node and the one or more first UEs.

Reduce the ISI in the wireless communications network by obtaining a beam for transmission out of the number of beams between the network node and the second UE. The beam is selected by taking the obtained measures of ISI per beam into account.

The ISI influences the quality of the beam. Therefore, by reducing the ISI in the wireless communications network by taking the obtained measures of ISI per beam into account, the transmission quality will be increased.

By not using beams that results in relatively low SINR due to inter symbol interference, the performance of the system is improved.

### BRIEF DESCRIPTION OF THE DRAWINGS

Examples of embodiments herein are described in more detail with reference to attached drawings in which:

FIG. 1 is a schematic diagram illustrating prior art.

FIG. 2 is a schematic block diagram illustrating embodiments of a wireless communications network.

FIG. 3 is a flowchart depicting embodiments of a method in a network node.

FIG. 4 is a schematic diagram illustrating embodiments herein.

FIGS. 5a and b are schematic block diagrams illustrating embodiments of a network node.

FIG. 6 schematically illustrates a telecommunication network connected via an intermediate network to a host computer.

FIG. 7 is a generalized block diagram of a host computer communicating via a base station with a user equipment over a partially wireless connection.

FIGS. 8 to 11 are flowcharts illustrating methods implemented in a communication system including a host computer, a base station and a user equipment.

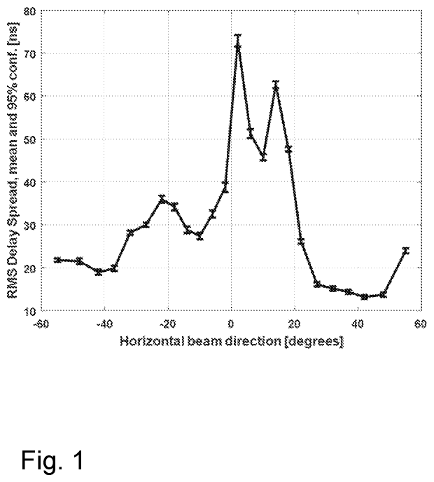

### DETAILED DESCRIPTION

According to example embodiments herein, ISI will be monitored and collected per beam over time. The historically collected interference, ISI or delay spread measurements will be used to e.g. influence, override, prohibit or reduce the usage of beams with high historical interference. Particularly, some embodiments herein concern the use of interference measures based on measured ISI in the uplink.

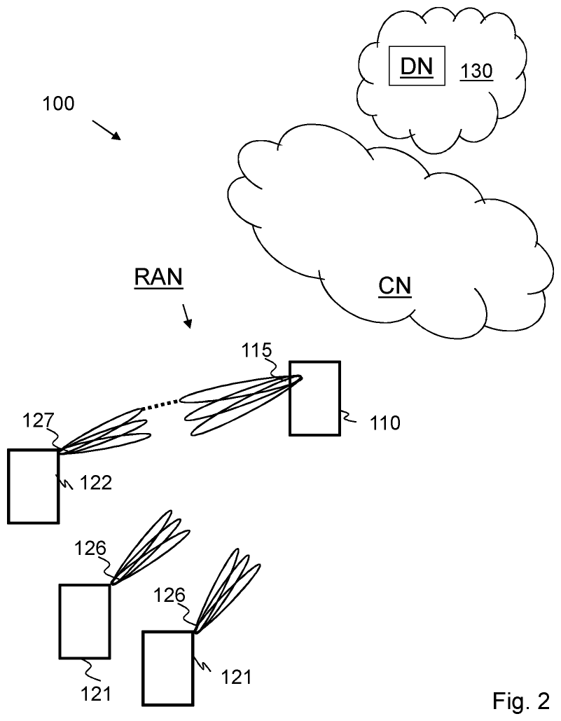

FIG. 2 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, W-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. OK but maybe you mean FIG. 2?

Network nodes such as a network node 110 operate in the wireless communications network 100, providing radio coverage by means of antenna beams, referred to as beams herein. The network node 110 provides a number of beams 115 and may use these beams for communicating with e.g. respective first and second User Equipments, UEs 121, 122, see below. The network node 110 is a radio node such as e.g. a base station or a UE.

In case of being a base station, the network node 110 provides radio coverage over a geographical area by means of antenna beams. The geographical area may be referred to as a cell, a service area, beam or a group of beams. The network node 110 may in this case be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within the cell served by network node 110 depending e.g. on the radio access technology and terminology used.

In case of being a UE, the network node 110 may e.g. be an NR device, a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

User Equipments operate in the wireless communications network 100, such as one or more first UEs 121 and a second UE 122. The respective one or more first UEs 121 and second UE 122 provide radio coverage by means of respective antenna beams 126, 127, also referred to as beams herein. The one or more first UEs 121 may be referred to as the first UEs herein. The second UE 122 may in some embodiments be one of the first UEs 121.

The first UEs 121 may be part of a beam learning process to get to know the behavior of the beams over time. This knowledge will be applied at a later stage for selecting a beam for the second UE 122 to be used for transmission with the network node 110.

Any of the first and second UEs, 121, 122 may e.g. be an NR device, a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Thus, the network node 110 provides a number of beams which may be used for transmissions between the network node 110 and respective one or more first UEs 121 and the second UE 122.

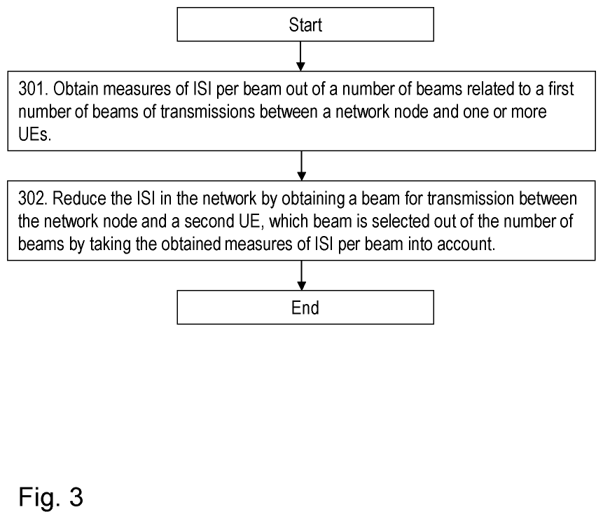

The methods according to embodiments herein are performed by the network node 110. As an alternative, a Distributed Node DN and functionality, e.g. comprised in a cloud 130 as shown in FIG. 3 may be used for performing or partly performing the methods.

Example embodiments of a method performed by a network node 110 for reducing ISI in a wireless communications network 100 will now be described with reference to a flowchart depicted in FIG. 3.

As mentioned above, the network node 110 provides a number of beams for transmissions between the network node 110 and the respective one or more first UEs, 121 and the second UE 122.

The method comprises the following actions, which actions may be taken in any suitable order.

Action 301

In order to reduce the ISI in the wireless communications network 100, the network node 110 according to embodiments herein, will learn from a number of beams used for transmission between the network node 110 and the respective one or more first UEs 121, how these beams are influenced by ISI. Based on this knowledge, selection of beams that are most affected by ISI can then be avoided in an upcoming transmission between the network node 110 and the second UE 122. For example, avoiding to select a strong LOS beam being reflected on an object directly behind the receiving UE 122, causing a high ISI. In order to determine the ISI in the wireless communications network 100, measurements indicating or correlating with the ISI will be collected. This collected information will then be taken into consideration when selecting a beam to use for transmission to a second UE 122, such as e.g. is described in action 302 below.

Thus, the network node 110 obtains measures of ISI per beam out of the number of beams related to transmissions between the network node 110 and the one or more first UEs 121, during a time period. Depending on the source of interference the ISI may vary over time. It may therefore be advantageous to gather or measure data related to the ISI per beam during a time period. By doing this beams exhibiting high ISI over time will be detected. Varying or transients measures of high ISI will then have a minor or negligible influence when determining the ISI per beam. The time period may e.g. be minutes or hours providing enough time to even out temporary changes in the environment such as busses passing by etc. Obtaining in this case may e.g. be receiving it from the UEs 121, e.g. by measuring it in the UEs 121 and then reporting the measurement to the network node 110. Obtaining may also mean to measure it at the network node 110.

According to some embodiments, the obtaining of the measures of ISI per beam out of the number of beams related to transmissions between the network node 110 and the one or more first UEs 121 comprises obtaining measures of data quality metrics per beam. Examples of data quality metrics may e.g. be path power, path time, delay spread, estimated ISI, adjusted RSRP measurements, channel state information measurements, resulting throughput and Block Error Rate (BLER). The data quality metrics per beam may be associated with respective any one or more out of: estimate of direction of the beam, estimate of distance to one of the at least one first UEs 121 using the beam, estimates of geographic position of one of the at least one first UEs 121 using the beam. These embodiments are preferably done in scenarios such as. Knowing the direction of the beam is advantageous since it indicates which beam is related to the measurement. Knowing the distance to the UE 121 is advantageous since it provides the possibility to differentiate between UEs within the same beam but at different distances from the base station. Knowing the geographic position of the UEs 121 is advantageous since this means that both the beam direction and the distance is known, providing at least the advantages described above. According to some of these embodiments obtaining measures of ISI per beam out of the number of beams related to transmissions between the network node 110 and the one or more first UEs 121 further comprises comparing the data quality metrics before and after a beam switching event. This is advantageous since if the beam switch is based on signal strength, the signal strength can be assumed equal on the old and new beam at the time of the switch. If the quality is changed anyway this is an indication of different ISI in the two beams.

According to some alternative embodiments the obtaining of the measures of ISI per beam out of the number of beams related to transmissions between the network node 110 and the one or more first UEs 121 may further be performed by estimating the ISI per beam, based on any one out of:
Uplink transmissions from one of the at least one first UEs 121, such as e.g. Sounding Reference Signal (SRS), uplink Demodulation Reference Signal (DMRS) transmissions. An uplink channel quality may e.g. be determined from the SRS and thereafter be used as an input or measure for the estimation of the ISI. Measured delay spread on SRS or DMRS transmission may also be used for the estimation.
Collected measures of the relative power and path delay beyond the cyclic prefix per beam, such as e.g. analysis of power delay profiles on the amount of energy outside of the cyclic prefix.
A comparison between measured RSRP and associated Channel Quality Indicator (CQI).

In some embodiments relating to machine learning, the time period may be represented by a learning period for learning a machine learning model. In these embodiments, obtaining measures of ISI per beam out of the number of beams related to transmissions between the network node 110 and the one or more first UEs 121 is performed by training the machine learning model based on measures of data quality metrics per beam. This will be explained in more detail below.

Action 302

The network node 110 now has learned from the number of beams how these beams are influenced by ISI. Based on this knowledge, selection of beams that are most affected by ISI will in this action be avoided in transmission between the network node 110 and the second UE 122. The network node 110 accordingly reduces the ISI in the wireless communications network 100 by obtaining a beam for transmission out of the number of beams between the network node 110 and the second UE 122, which beam is selected by taking the obtained measures of ISI per beam into account.

Obtaining in this case may e.g. be receiving it from a UE 122, where the UE 122 selected the beam based on a specific criterion, deciding it at the network node 110, receiving it from a node in the cloud. This may be performed in a number of ways.

According to some first embodiments, the network node 110 may group the beams with ISI below a threshold in a group of beams, i.e. this will be a group of acceptable beams with less ISI, and then select a beam from that group for a transmission with the second UE 122. Thus, the selected beam is obtained from a group of one or more beams out of the number of beams. Each beam in the group of one or more beams has a measure of ISI that is below a first threshold. Thus, the number of beams which can be selected as a transmission beam is reduced based on the measured ISI. In this way beams exhibiting an excessive ISI can be discarded. The measure of ISI herein may be indirectly related to the actual ISI, e.g. be a function of the ISI. It may be the relation between the signal, e.g. the energy within the cyclic prefix or the energy in the following signal and the ISI. The measure of ISI may refer to the Signal-to-Interference Ratio (SIR) caused by the ISI. As an example, the SIR may be above a first threshold, which may be e.g. 20-30 dB.

According to some second embodiments, the transmission occurrence of reference signals in beams exhibiting ISI above a second threshold is reduced. The beam is thereafter obtained by selecting it based on the reference signals when measured. In this way, reference signals in beams having a high ISI, i.e. a low SIR, will be transmitted less frequently. The probability of these beams being selected, by e.g. the second UE 122, will therefore be reduced, leading to a reduction in ISI in the wireless communications network. The second threshold may e.g. be a SIR of 15-20 dB.

According to some third embodiments, the power of reference signals in beams exhibiting ISI above a third threshold is reduced. The beam is thereafter obtained by selecting it based on the reference signals when measured. In this way the probability of a beam exhibiting an ISI above, i.e. a SIR below, the third threshold will be reduced. If the UE 122, selects the beam, this embodiment ensures that the UE 122 will not favor such beams. The third threshold may e.g. be 15-20 dB.

According to some fourth embodiments, an RSRP measure per beam is obtained. The RSRP measure is then adjusted based on the ISI measure per beam. The beam is thereafter obtained by selecting it based on the adjusted RSRP measure. The RSRP may e.g. be obtained by the UE 122 performing measurements of the RSRP and then transmitting the obtained measurements to the network node 110. A multiple of RSRP may be obtained, corresponding to different beams. The RSRP measure may be adjusted by applying the ISI as a correction term or bias. The beam is thereafter obtained by e.g. the UE 122 or the network node 110 selecting the beam based on the adjusted RSRP.

According to some fifth embodiments, a beam selection offset is determined based on the obtained measure of ISI per beam. The beam is thereafter obtained by selecting it based on the selection offset. The selection may e.g. be performed by the UE 122 and reported to the network node 110. The UE 122 may in this case in beforehand have received the offset from the network node 110 or determined it based on ISI measures signaled from the network node 110 or be determined at the UE 122 directly.

According to some of the embodiments relating to machine learning described in conjunction with action 301 above, when the machine learning model is trained, the machine learning model obtains the beam from a group of one or more beams out of the number of beams. Each beam in the group of one or more beams has a measure of ISI that is below a fourth threshold.

Embodiments herein such as mentioned above will now be further described and exemplified. The text below is applicable to and may be combined with any suitable embodiment described above.

ISI Measure Per Beam

To reduce ISI in the wireless communications network 100, the ISI interference per beam towards the first UEs 121 will first be measured or estimated, as explained under action 301 above. There are different embodiments related to this action. In some embodiments an interference estimate is obtained through estimation of ISI in the reciprocal uplink, such as estimating the ISI per beam based on uplink transmission one of the first UEs 121. Uplink transmissions that may allow for estimation of ISI may e.g. be SRS sounding and/or uplink DMRS transmissions.

In some other embodiments the ISI interference is estimated based on measured delay spread on uplink SRS or DMRS symbols.

In yet some other embodiments the path delay and power is explicitly estimated and the relative power and excessive delay beyond cyclic prefix is measured per path. An example of this is to estimate the ISI per beam based on collected measures of the relative power and path delay beyond the cyclic prefix per beam. With relative power is herein meant calculating the SIR caused by ISI, i.e. The power of the signal relative to the power outside of the cyclic prefix of the previous signal.

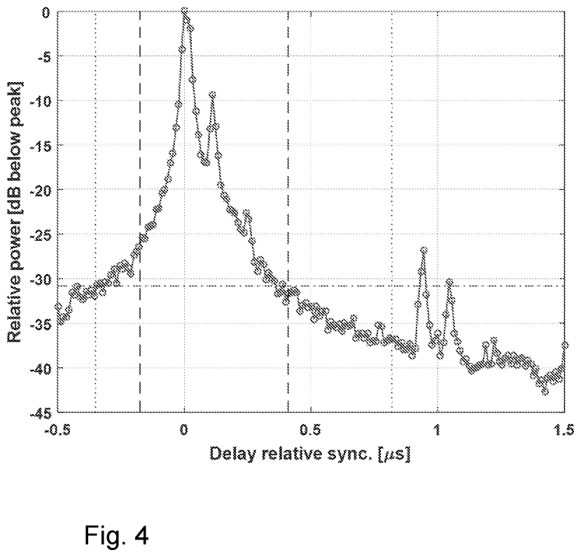

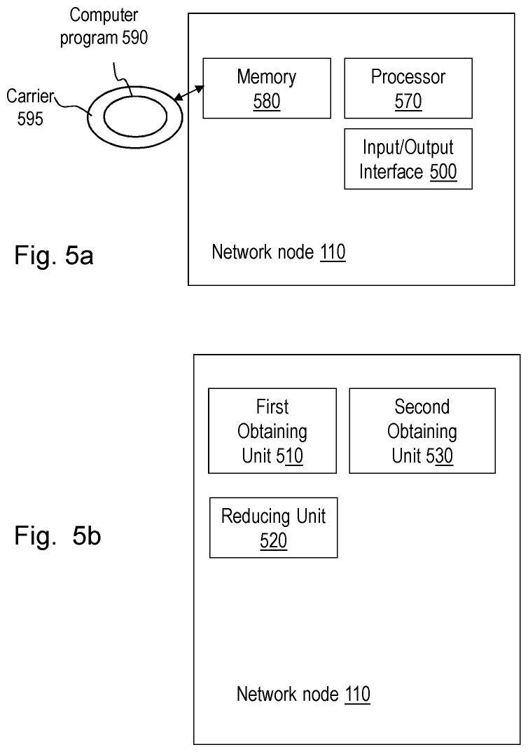

An example of a measurement of path delay and power relatively the cyclic prefix of the procedure according to this embodiment is shown in a diagram of FIG. 4, wherein the X axis represents the relative power in dB below peak power and the Y axis represents the delay relative to the strongest path in ps. In FIG. 4, a power delay profile is created by Inverse Fast Fourier Transforming (IFFT) reference signals over frequency. The cyclic prefix window, e.g. the window between two symbols as explained above, is indicated as vertical dashed and dotted lines for 120 and 60 kHz subcarrier spacing assuming that the receiver window is placed ⅓ of cyclic prefix length before the strongest path (which is located at time 0 in FIG. 5). As can be seen, there are relatively strong paths around 1 μs. Their relative power, here −27 and −30 dB, and time after end of cyclic prefix, here 0.5 and 0.7 μs, for 120 kHz subcarrier spacing, may be collected statistically as an indication of the ISI. For examples as two times the power times time.

In some other embodiments, the ISI is estimated trough a comparison between measured RSRP and associated CQI, such as e.g. by analyzing the relation between the RSRP and the SINR as a function of CQI. An example of this is estimating the ISI per beam based on a comparison between measured RSRP and associated CQI. The CQI is obtained after a beam has been selected, when beam specific CSI feedback for link adaptation later is obtained. With link adaption when used herein means the ability to adapt the modulation scheme and the coding rate of error corrections according to the quality of the radio link.

In a related embodiment an SINR is estimated based on reported CQI together with outer-loop based link adaptation adjustments. With outer-loop based link adaption adjustments is herein meant link adaptation including offset adjustment in the mapping between CQI measurement and used MCS.

In another embodiment a vector of ISI estimates per beam is accumulated. A vector of ISI estimates means a list of estimates. Different vector elements correspond to different radio node distances, such as e.g. distance to a UE 122 using the beam, to the network node 110. Vector elements when used herein means individual ISI estimates at different distances within a beam. Other similar metrics may be used, such as e.g. geographic position of the respective first UE 121. Thus interference estimates are provided as a function of angle, which may be referred to as beam index, as well as radius, which may be referred to as vector index. The distance to the respective first UE 121 may e.g. be parametrized based on timing advance, RSRP or pathloss. The timing advance corresponds to twice the length of time a signal takes to reach the network node 110 from the UE 121.

In some other embodiments, interference estimates or interference related correction factors are binned, that is they are divided into a series of intervals in a two dimensional coordinate system. The coordinate system may be either in polar coordinates or Euclidian coordinates. A polar coordinate system is a two-dimensional coordinate system in which each point on a plane is determined by a distance from a reference point and an angle from a reference direction. Euclidian coordinates are the ordinary coordinates defined with x,y and/or z axes in space. An azimuthal coordinate is a three-dimensional coordinate system defined by distance azimuth and elevation. The azimuthal coordinate is obtained from the direction of the corresponding beam.

Reduce the Usage of Beams with High ISI

To reduce the ISI, the beams exhibiting high ISI must be avoided during beam selection for transmission with the second UE 122, as explained under action 302 above. As further explained there, the statistical interference measure is therefore used to impact the selection of beams.

In some embodiments the network node 110, receives multiple RSRP measurements corresponding to different beams. The interference measurements may then be applied as a correction term or bias to impact the beam selection. Thus, the interference measurement may be applied as an adjustment of the RSRP measurement and the beam may thereafter be obtained by selecting it based on the adjusted RSRP measure.

In some embodiments the second UE 122 selects the best beam to use. The selection may be made by using a beam specific beam selection offset. The beam selection offset may be based on the ISI measures reported or signaled from the network node 110, to the second UE 122. The signaling of the beam selection offset may be pre-configured in higher layer protocols or signaled together with a message requesting beam selection to be performed.

In some embodiments the network node 110 reduces the occurrence of reference signal, such as e.g. a CSI-RS, transmissions on beams with an ISI measure above a certain threshold, such as e.g. the second threshold. As an example of this, the ISI may be reduced by reducing the transmission occurrence of reference signals in beams exhibiting ISI above a second threshold, and thereafter obtaining the beam by selecting it based on the reference signal when measured or determined. Thus, if a beam or a beam direction is deemed to historically result in excessive ISI, then this beam direction is less frequently transmitted as a beamforming candidate in beam sweeping algorithms.

In some embodiments the network node 110 reduces the transmission power of reference signals, such as e.g. CSI-RS, on beams with an ISI measure above a certain threshold, such as e.g. the third threshold. If a beam or beam direction is deemed to historically result in excessive ISI, then the reference signal, such as e.g. CSI-RS, of this beam direction is transmitted with a lower power to ensure that the second UE 122 is not favoring that beam direction when determining the strongest beam direction. The beam is then obtained by selecting it based on the measured reference signals.

In some embodiments traffic load is considered when the ISI or impact of the ISI is estimated. High traffic load implies high ambient interference and consequently less direct impact of ISI. In these embodiments a high ambient interference will thus reduce the impact of suppressing the beams with large ISI. Thus, in these embodiments, the ISI may not be suppressed by the network node 110.

An advantage of the described embodiments is that the wireless communications network 100 or cell can be configured with wider sub-carrier spacing, thereby improving latency. This is since wider sub-carrier spacing means shorter time per symbol. Shorter symbol times can be used if the delay spread is small and the risk for high ISI is low.

Machine Learning

Some embodiments relate to machine learning, wherein the ISI is not estimated explicitly. The ISI may instead be implicitly incorporated in the beam selection by looking at the change in a data quality metrics before and after switching beams at the network node 110. The data quality metrics may e.g. be based on one or more of path power, path time, delay spread, adjusted RSRP measurements etc. In a learning phase or learning period for learning a machine learning model, beam switching events may be logged with a position estimate, such as e.g. the beam index for angle and a reported RSRP for radius, and a data quality metric, e.g. channel state information measurements, resulting throughput, BLER, etc. Thus, as an example, the time period described above may be represented by this learning period, and the measures of ISI per beam are obtained by training the machine learning model based on measures of data quality metrics, such as e.g. the metrics exemplified above, per beam. A beam switch event may be defined as comprising binned intervals of the position estimate, nominal RSRP values of the beam before switching (beam X) and the beam after switching (beam Y) as well as a data quality metric before and after the beam switch. When the machine learning model is trained, the machine learning model obtains the beam from a group of one or more beams. Each beam in this group of one or more beams has a measure of ISI that is below, or a SIR that is above, the fourth threshold. The fourth threshold may e.g. be 20 dB. For example, for a position estimate bin, if switching from beam X to beam Y results in higher data quality metric, the switch event may be adjusted to become more likely to occur. This may e.g. be achieved by shifting the nominal RSRPs of the beams in the bin. Given enough training time, the network node 110 will avoid beam switches that create a lot of ISI, thus reducing the ISI in the wireless communications network 100.

To perform the method actions above for reducing ISI in a wireless communications network 100, the network node 110 may comprise the arrangement depicted in FIGS. 5a and 5b. As mentioned above, the network node 110 is adapted to provide a number of beams for transmissions between the network node 110 and respective one or more first User Equipments, UEs, 121, and a second UE 122.

The network node 110 may comprise an input and output interface 500 configured to communicate e.g. with the UE 120, 122. The input and output interface 500 may comprise a wireless receiver (not shown) and a wireless transmitter (not shown).

The network node 110 is configured to, e.g. by means of a first obtaining unit 510 in the network node 110, during a time period, obtain measures of ISI per beam out of the number of beams related to transmissions between the network node 110 and the one or more first UEs 121.

The network node 110 may further be configured to obtain measures of ISI per beam out of the number of beams related to transmissions between the network node 110 and the one or more first UEs 121 by obtaining measures e.g. by means of the first obtaining unit 510, of data quality metrics per beam. The data quality metrics per beam is in this embodiment associated with respective any one or more out of: estimate of direction of the beam, estimate of distance to one of the at least one first UEs 121 using the beam, and estimates of geographic position of one of the at least one first UEs 121 using the beam. According to some embodiments of this embodiment, the network node 110 is further configured to obtain, e.g. by means of the first obtaining unit 510, measures of ISI per beam out of the number of beams related to transmissions between the network node 110 and the one or more first UEs 121 by comparing the data quality metrics before and after a beam switching event.

According to some embodiments the network node 110 is further configured to obtain, e.g. by means of the first obtaining unit 510, measures of ISI per beam out of the number of beams related to transmissions between the network node 110 and the one or more first UEs 121 by estimating the ISI per beam based on any one out of:
Uplink transmissions from one of the at least one first UEs 121.
Collected measures of the relative power and path delay beyond the cyclic prefix per beam.
A comparison between measured RSRP and associated Channel Quality Indicator, CQI.

According to some embodiments relating to machine learning the time period is adapted to be represented by a learning period for learning a machine learning model. The network node 110 is according to this embodiment configured to obtain, e.g. by means of the first obtaining unit 510, measures of ISI per beam out of the number of beams related to transmissions between the network node 110 and the one or more first UEs 121 by training the machine learning model based on measures of data quality metrics per beam.

The network node 110 is further configured to, e.g. by means of a reducing unit 520 in the network node 110, reduce the ISI in the wireless communications network 100 by obtaining, e.g. by means of a second obtaining unit 530 in the network node 110, a beam for transmission out of the number of beams between the network node 110 and the second UE 122, which beam is selected by taking the obtained measures of ISI per beam into account.

According to some first embodiments, the network node 110 is further configured to obtain, e.g. by means of the second obtaining unit 530, the beam for transmission out of the number of beams between the network node 110 and the second UE 122. The beam is selected by taking the obtained measures of ISI per beam into account by obtaining the selected beam from a group of one or more beams out of the number of beams. Each beam in the group of one or more beams is adapted to have a measure of ISI that is below a first threshold.

According to some second embodiments, the network node 110 is configured to reduce the transmission occurrence of reference signals in beams exhibiting ISI above a second threshold. The beam is thereafter obtained, e.g. by means of the second obtaining unit 530, by selecting it based on the reference signals when measured.

According to some third embodiments, the network node 110 is configured to reduce the power of reference signals in beams exhibiting ISI above a third threshold. The beam is thereafter obtained, e.g. by means of the second obtaining unit 530, by selecting it based on the reference signals when measured,

According to some fourth embodiments, the network node 110 is configured to obtain a RSRP, measure per beam. The RSRP measure is adjusted based on the ISI measure per beam. The beam is thereafter obtained, e.g. by means of the second obtaining unit 530, by selecting it based on the adjusted RSRP measure.

According to some fifth embodiments, the network node 110 is configured to determine a beam selection offset based on the obtained measure of ISI per beam. The beam is thereafter obtained, e.g. by means of the second obtaining unit 530, by selecting it based on the selection offset.

According to some of the embodiments relating to machine learning described above the network node is 110 is configured to obtain, e.g. by means of the second obtaining unit 530, the beam for transmission out of the number of beams between the network node 110 and the second UE 122. The beam is selected by taking the obtained measures of ISI per beam into account, by:

when the machine learning model is trained, the machine learning model obtaining the beam from a group of one or more beams out of the number of beams. Each beam in the group of one or more beams has a measure of ISI that is below a fourth threshold according to this embodiment.

The embodiments herein may be implemented through a respective processor or one or more processors, such as a processor 570 of a processing circuitry in the network node 110 depicted in FIG. 5b, together with a respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 580 comprising one or more memory units. The memory comprises instructions executable by the processor 570. The memory 580 is arranged to be used to store e.g. information about the ISI per beam, data quality metrics per beam, estimate of the direction of the beams, estimate of distance to a UE 122 using a beam, estimate of geographic position of a UE 122 using a beam, beam switching events, RSRP per beam, CQI per beam, the first and second and third threshold and applications to perform the methods herein when being executed in the network node 110.

Those skilled in the art will also appreciate that the units in network node 110 mentioned above may refer to a combination of analog and digital circuits, and/or one or more processors configured with software and/or firmware, e.g. stored in network node 110 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 590 comprises instructions, which when executed by the respective at least one processor 570, cause the at least one processor 570 of the network node 110 to perform the actions above.

In some embodiments, a carrier 595 comprises the computer program 590, wherein the carrier 695 is one of an electronic signal, an optical signal, an electromagnetic signal, a magnetic signal, an electric signal, a radio signal, a microwave signal, or a computer-readable storage medium.

Further Extensions and Variations

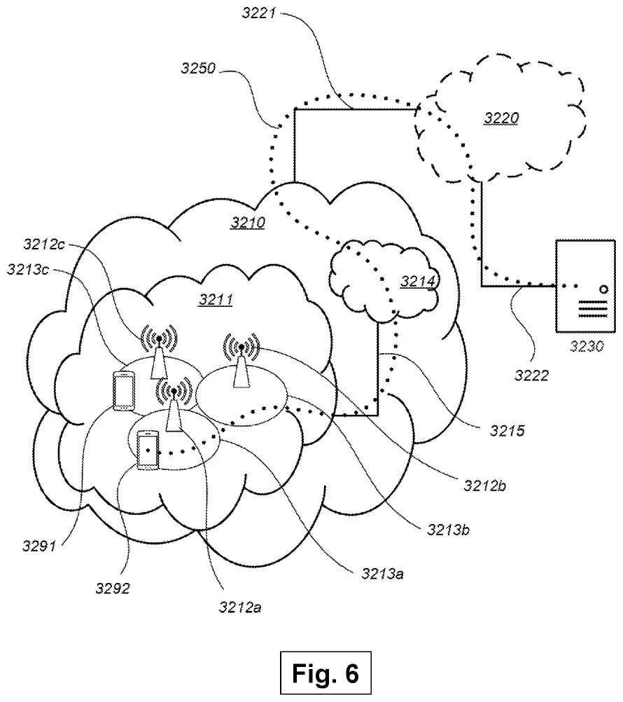

With reference to FIG. 6, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the first UEs 121 or the second UE 122 such as a Non-AP STA 3291 located in coverage area 3213c is configured to wirelessly connect to, or be paged by, the corresponding base station 3212c. A second UE 3292 e.g. the first UEs 121, the second UE 122 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

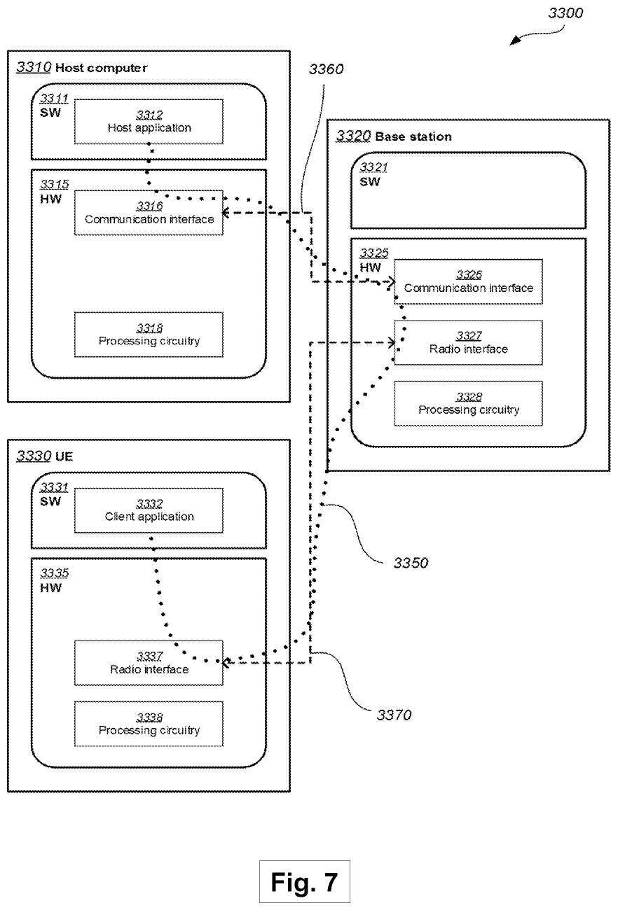

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

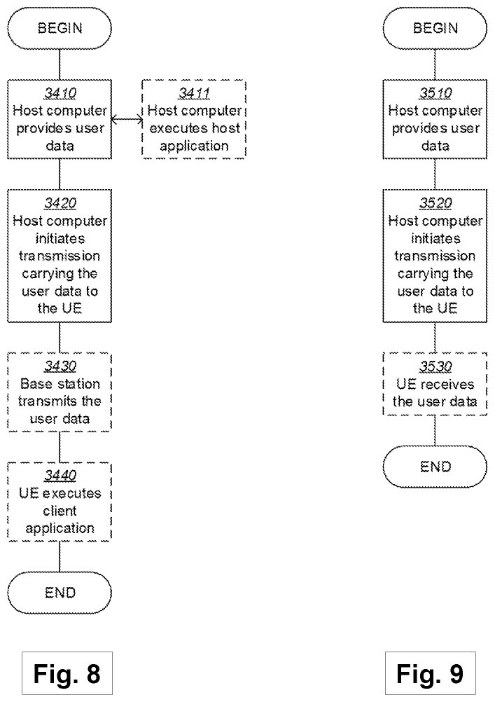

FIG. 8 is a flowchart illustrating a method implemented in a communication system, in accordance with one embodiment. The communication system includes a host computer, a base station such as a AP STA, and a UE such as a Non-AP STA which may be those described with reference to FIGS. 6 and 7. For simplicity of the present disclosure, only drawing references to FIG. 8 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 9 is a flowchart illustrating a method implemented in a communication system, in accordance with one embodiment. The communication system includes a host computer, a base station such as a AP STA, and a UE such as a Non-AP STA which may be those described with reference to FIGS. 6 and 7. For simplicity of the present disclosure, only drawing references to FIG. 9 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

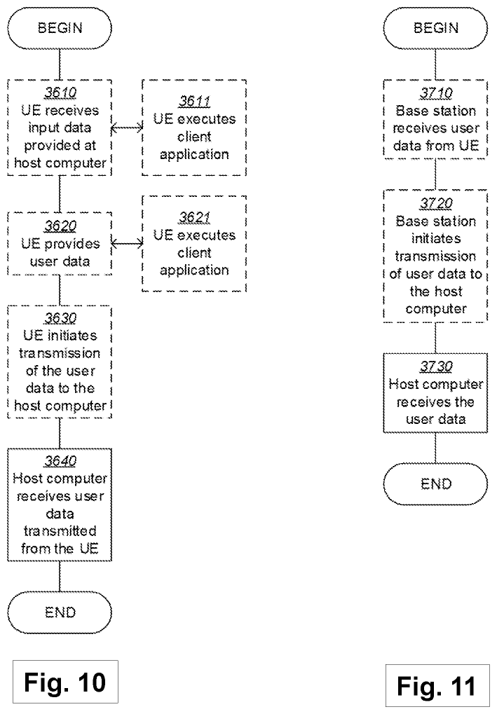

FIG. 10 is a flowchart illustrating a method implemented in a communication system, in accordance with one embodiment. The communication system includes a host computer, a base station such as a AP STA, and a UE such as a Non-AP STA which may be those described with reference to FIGS. 6 and 7. For simplicity of the present disclosure, only drawing references to FIG. 10 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as a AP STA, and a UE such as a Non-AP STA which may be those described with reference to FIGS. 6 and 7. For simplicity of the present disclosure, only drawing references to FIG. 11 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a network node for reducing Inter-Symbol Interference (ISI) in a wireless communications network, which network node provides a number of beams for transmissions between the network node and respective one or more first user equipments (UEs) and a second UE, the method comprising:
during a time period, obtaining measures of ISI per beam out of the number of beams related to transmissions between the network node and the one or more first UEs; and
reducing the ISI in the wireless communications network by obtaining a beam for transmission between the network node and the second UE, which beam is selected out of the number of beams by taking the obtained measures of ISI per beam into account.

2. The method of claim 1, wherein obtaining measures of ISI per beam out of the number of beams of transmissions between the network node and the one or more first UEs comprises:
obtaining measures of data quality metrics per beam, the data quality metrics per beam being associated with respective any one or more out of: estimate of direction of the beam, estimate of distance to one of the at least one first UEs using the beam, and estimates of geographic position of one of the at least one first UEs using the beam.

3. The method of claim 2, wherein obtaining measures of ISI per beam out of the number of beams related to transmissions between the network node and the one or more first UEs further comprises:
comparing the data quality metrics before and after a beam switching event.

4. The method of claim 1, wherein reducing the ISI in the wireless communications network by obtaining the beam for transmission between the network node and the second UE, which beam is selected out of the number of beams by taking the obtained measures of ISI per beam into account is performed by:
obtaining the selected beam from a group of one or more beams out of the number of beams, wherein each beam in the group of one or more beams has a measure of ISI that is below a first threshold.

5. The method of claim 1, wherein obtaining measures of ISI per beam out of the number of beams related to transmissions between the network node and the one or more first UEs is further performed by estimating the ISI per beam based on any one out of:
uplink transmissions from one of the at least one first UEs,
collected measures of the relative power and path delay beyond the cyclic prefix per beam, and
a comparison between measured Reference Signal Received Power (RSPR) and associated Channel Quality Indicator (CQI).

6. The method of claim 1, wherein reducing the ISI in the wireless communications network by obtaining the beam for transmission out of the number of beams between the network node and the second UE, which beam is selected by taking the obtained measures of ISI per beam into account is performed by any one out of:
reducing the transmission occurrence of reference signals in beams exhibiting ISI above a second threshold, and thereafter obtaining the beam by selecting it based on the reference signals when measured,
reducing the power of reference signals in beams exhibiting ISI above a third threshold, and thereafter obtaining the beam by selecting it based on the reference signals when measured,
obtaining a Reference Signal Received Power, RSRP, measure per beam, adjusting the RSRP measure based on the ISI measure per beam, and thereafter obtaining the beam by selecting it based on the adjusted RSRP measure, and
determining a beam selection offset based on the obtained measure of ISI per beam and thereafter obtaining the beam by selecting it based on the selection offset.

7. The method of claim 1, wherein the time period is represented by a learning period for learning a machine learning model, and wherein obtaining measures of ISI per beam out of the number of beams related to transmissions between the network node and the one or more first UEs is performed by:
training the machine learning model based on measures of data quality metrics per beam.

8. The method of claim 7, wherein reducing the ISI in the wireless communications network by obtaining the beam for transmission out of the number of beams between the network node and the second UE, which beam is selected by taking the obtained measures of ISI per beam into account is performed by:
when the machine learning model is trained, the machine learning model obtains the beam from a group of one or more beams out of the number of beams, wherein each beam in the group of one or more beams has a measure of ISI that is below a fourth threshold.

9. A computer program product comprising a non-transitory computer readable medium storing a computer program comprising instructions, which when executed by a processor, cause the processor to perform the method of claim 1.

10. (canceled)

11. A network node for reducing Inter-Symbol Interference (ISI) in a wireless communications network, which network node is adapted to provide a number of beams for transmissions between the network node and respective one or more first user equipments (UE) and a second UE, the network node being configured to:
during a time period, obtain measures of ISI per beam out of the number of beams related to transmissions between the network node and the one or more first UEs; and
reduce the ISI in the wireless communications network by obtaining a beam for transmission out of the number of beams between the network node and the second UE, which beam is selected by taking the obtained measures of ISI per beam into account.

12. The network node of claim 11, further being configured to obtain measures of ISI per beam out of the number of beams related to transmissions between the network node and the one or more first UEs comprises:
obtain measures of data quality metrics per beam, the data quality metrics per beam being associated with respective any one or more out of: estimate of direction of the beam, estimate of distance to one of the at least one first UEs using the beam, and estimates of geographic position of one of the at least one first UEs using the beam.

13. The network node of claim 12, wherein the network node is further configured to obtain measures of ISI per beam out of the number of beams related to transmissions between the network node and the one or more first UEs by comparing the data quality metrics before and after a beam switching event.

14. The network node of claim 11, wherein the network node is further configured to obtain the beam for transmission out of the number of beams between the network node and the second UE, which beam is selected by taking the obtained measures of ISI per beam into account by obtaining the selected beam from a group of one or more beams out of the number of beams, wherein each beam in the group of one or more beams is adapted to have a measure of ISI that is below a first threshold.

15. The network node of claim 11, wherein the network node is further configured to obtain measures of ISI per beam out of the number of beams related to transmissions between the network node and the one or more first UEs by estimating the ISI per beam based on any one out of:
uplink transmissions from one of the at least one first UEs,
collected measures of the relative power and path delay beyond the cyclic prefix per beam, and
a comparison between measured Reference Signal Received Power and associated Channel Quality Indicator.

16. The network node of claim 11, wherein the network node is configured to obtain the beam selected for transmission out of the number of beams between the network node and the second UE, which beam is selected by taking the obtained measures of ISI per beam into account by any one out of:
reducing the transmission occurrence of reference signals in beams exhibiting ISI above a second threshold, and thereafter obtaining the beam by selecting it based on the reference signals when measured,
reducing the power of reference signals in beams exhibiting ISI above a third threshold, and thereafter obtaining the beam by selecting it based on the reference signals when measured,
obtaining a Reference Signal Received Power (RSRP) measure per beam, adjusting the RSRP measure based on the ISI measure per beam, and thereafter obtaining the beam by selecting it based on the adjusted RSRP measure or
determining a beam selection offset based on the obtained measure of ISI per beam and thereafter obtaining the beam by selecting it based on the selection offset.

17. The network node of claim 11, wherein the time period is adapted to be represented by a learning period for learning a machine learning model, and wherein network node is configured to obtain measures of ISI per beam out of the number of beams related to transmissions between the network node and the one or more first UEs by training the machine learning model based on measures of data quality metrics per beam.

18. The network node of claim 17, wherein network node is configured to obtain the beam for transmission out of the number of beams between the network node and the second UE, which beam is selected by taking the obtained measures of ISI per beam into account by:
when the machine learning model is trained, the machine learning model obtaining the beam from a group of one or more beams out of the number of beams, wherein each beam in the group of one or more beams has a measure of ISI that is below a fourth threshold.
